(19) United States
(12) Patent Application Publication
(10) Pub. No.: US 2008/0034930 A1
(43) Pub. Date: Feb. 14, 2008

(54) Non slip screw

(76) Inventors: Ruediger H. Landes, Norman, OK (US); Margarete E.E. Landes, Norman, OK (US); Franziska C. Landes, Norman, OK (US); Tiemo S. Landes, Norman, OK (US)

Correspondence Address: Ruedger Landes, 927 Birch Dr., Norman, OK, 73072, US

(21) Appl. No.: 11/501,482

(22) Filed: Aug. 8, 2006

(51) Int. Cl. B25B 15/00; B25B 23/00; B25B 13/48

(52) U.S. Cl. 81/436; 81/460; 411/402

(57) ABSTRACT

A non-slip screw of the type having a threaded shank and an embedded slotted head, including a locking surface defined in the screw head by a central transverse slot which extends into the top of the head for engagement with the driver blade tip. The locking surface includes a pair of off-set blades outwardly extending walls extending downwardly from each end of the transverse slot. A river having its exterior blade tip configured complementary with the pairs of off-set blades outwardly extending inclined walls is engageable with the locking surface, so as to rotate the screw head in either direction.

### CROSS-REFERENCE TO RELATED APPLICATION

60576,746 Filed Jun. 3, 2004

### STATEMENT REGARDING FEDERALLY SPONSORED RESEARCH OR DEVELOPMENT

Not applicable

### REFERENCE TO SEQUENCE LISTING

Not applicable

### BACKGROUND OF THE INVENTION

### Field of the Invention

The present invention relates to a fastening device and related hand tool driver for the purpose of holding, securing and attaching. The newly designed fastener or screw embodies a non-slip embedded slot design to withstand typical industry pressure as used on similar fasteners for attachment

Threaded screws, particularly screws having a modified head, such that the driver blade is capable of “locking” into the head during screw driving and removal of the screw.

It is with regard to this background information that the improvements available for the present invention have evolved.

### SUMMARY OF THE INVENTION

The device consists of a newly designed screw head and screwdriver blade. The screw head has an embedded slot with angled sides. The blade of the driver has wedged faces acting as a male attachment to the ‘female’ fastener or screw. See the Illustrations. Contrary to regular screws under torque, the driver will be held in place by the screws design. Since the torque is applied to the whole screw head and not just the center as with Phillips screws the head will not be ruined that easily under strong torque or by a misaligned screwdriver.

The device consists of a newly designed fastener head and driver blade. The device can be used wherever regular screws, Phillip screws or other screws are used, in particular for high torque jobs. Flat head screwdrivers can be used to tighten the screws, if the special non-slip screwdriver is not available.

According to the present invention, a fastener having a conventional threaded shank is modified, such that the transverse slot extending through the head of the screw is provided with an embedded slot locking surface. The locking surface is defined by opposed pairs of downwardly extending walls at each end of the slot and ageing under the upper slot, said walls being inclined away from the longitudinal axis of the screw shank. The driver blade is modified such that its exterior tip has a matching ‘male’ end to the fasteners ‘female’ end fitting accordingly and locking the surface. The result is a fastener screw which will not slip from the screwdriver during installation of the fastener.

The present invention is embodied in a new and novel fastener and driver device apparatus or for the installation of screws as used similarly in industries of all types.

This invention relates to screws and the drivers required securing such screws in most types of materials.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and. scope of the present invention.

Further, the purpose of the foregoing abstract is to enable the U.S. Patent and Trademark Office and the public generally, and especially the scientists, engineers and practitioners in the art who are not far with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new non-slip screw and driver apparatus and method which has many of the advantages of the screws mentioned heretofore and many novel features that result in a non-slip screw which is not anticipated, rendered obvious, suggested, or even implied by any of the prior art tool guides, either alone or in any combination thereof.

It is another object of the present invention to provide a new non-slip screw which may be easily and efficiently manufactured and marketed.

It is a further object of the present invention to provide a new non-slip screw and driver device which is of a durable and reliable construction.

An even further object of the present invention is to provide a new non-slip screw and driver device which is susceptible of a low cost of manufacture with regard to both materials and labor, and which accordingly is then susceptible of low prices of sale to the consuming public, thereby making such non-slip screw and driver devices economically available to the buying public.

Still yet another object of the present invention is to provide a new non-slip screw and driver device which provides in the apparatuses and methods of the prior art some of the advantages thereof, while simultaneously overcoming some of the disadvantages normally associated therewith.

Yet another object of the present invention is to provide a new non-slip screw and driver device which includes a newly designed screw head (see illustrations) typical screw shaft and hand tool driver.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### ILLLUSTRATIONS

The accompanying drawing depicts an application especially suited in connection with a blade driven by a hand held power screw driver as depicted within the specification.

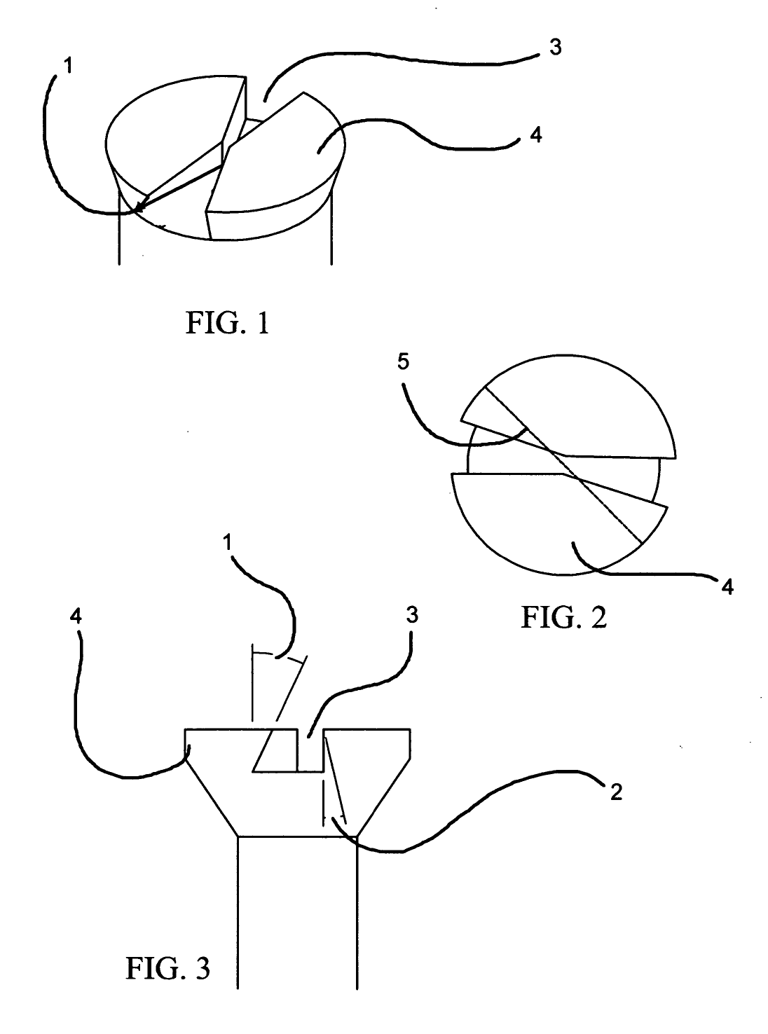

FIG. 1

A perspective view of the top and side of the device.

FIG. 2

A perspective view of the top side of the device.

FIG. 3

A perspective view of the side of the

### DESCRIPTION OF THE PREFERRED EMBODIMENT

Referring now to FIG. 1, numeral 1, depicts the nonzero angle of the screw wall slot 3 directly across from the zero angle slot wall as depicted by numeral 2 in FIG. 3. FIG. 1, numeral 3 depicts the slot which runs across the entire face 4 of the screw head. FIG. 2, numeral 5 depicts location of the nonzero wall throughout the screw head. FIG. 3, depicts the side angle of the nonzero wall 1 in reference to the zero wall 2 as the parameters of the slot 3 within the head of the screw 4.

When in the tightening mode, the blade is in a locking position. This is achieved when the face of the slot is pushed by the blade into the nonzero angle; the opposite face of the slot has a zero angle as depicted.

This allows for a quick release of the blade, once there is no torque on the screw driver. In applications where both the tightening as well as the loosening of the screw is difficult a screw with a head with locking positions in both directions can be used.

1. The combination of a driver and a non-slip screw including:
a. a driver having a blade tip with outwardly extending inclined edges in opposition to the screws head; and
b. a threaded screw having an embedded slotted head, including a locking surface in the form of two diametrically opposed triangles, offset above and below each other, said opposed triangles being defined by a central slot extending diametrically from one side of the screw head to the other and at each end of said slot a pair of off-set matching walls.

2. A hand held non-slip screw and driver device according to claim 1 wherein the device embodies a hand grip at one end of the device.

3. A non-slip screw and driver device according to claim 1 wherein the device embodies an open entry notch to allow the driver blade entrance and slight turn for the locking point.

4. A non-slip screw and driver device according to claim 1 wherein the screw device embodies a threaded shank or shaft.

5. A non-slip screw and driver device according to claim 1 wherein the driver device embodies a blade which locks into the non-slip screw with a slight turn of the handle and shaft.
